(19) United States
(12) Patent Application Publication
(10) Pub. No.: US 2004/0184759 A1
(43) Pub. Date: Sep. 23, 2004

(54) Integrated optical fiber collimator

(76) Inventors: Ying-Moh Liu, Saratoga, CA (US); Cheng-Hsi Miao, San Jose, CA (US)

Correspondence Address: Billy Lau, 486 Vista Del Norte, Walnut, CA, 91789-1605, US

(21) Appl. No.: 10/392,464

(22) Filed: Mar. 18, 2003

(51) Int. Cl. G02B 6/00

(52) U.S. Cl. 385/147

(57) ABSTRACT

The present invention relates to an optical fiber system that includes an integrated optical fiber collimator with a built-in photodetector. The integrated optical fiber collimator according to an embodiment of the present invention includes a housing, an optical fiber, and a collimating lens system having at least one lens that is in optical communication with an optical fiber, a beams splitter in the light path in the housing to divert a portion of the light traveling inside the housing to at least one photodetector.

### FIELD OF THE INVENTION

This invention generally relates to optical fiber technology. Particularly, this invention relates to an optical fiber system that employs an optical fiber collimator with an integrated photodetector.

### BACKGROUND OF THE INVENTION

Optical fiber technology is widely applied in the field of communications, including telecommunication, data communication, and cable television. There are numerous optical fiber communication system applications that require the sensing and monitoring of light traveling in an optical fiber. A representative application is nonlinearity control in an optical fiber. Monitoring and regulating the power level of the light traveling in the optical fiber can control some of the nonlinearities in an optical fiber. Another representative application is in a wavelength division multiplexing optical fiber communication system. The power level of each component wavelength is monitored and equalized in most wavelength division multiplexing optical fiber communication systems to improve transmission performance.

A conventional method for monitoring the light in an optical fiber is to break the optical fiber and splice in a light-tapping component to tap off a portion of the light traveling in the optical fiber to a second optical fiber. Representative light-tapping component includes splitters and couplers. A photodetector monitors the tapped-off light through the second optical fiber. Another conventional method for monitoring the light in an optical fiber is to break the optical fiber and splice in a specially prepared optical fiber that has an etched section. The specially prepared optical fiber taps light off the optical fiber by allowing light to leak from the etched section. A photodetector monitors the light that leaks from the etched section. Both of these conventional methods require breaking the optical fiber and splicing in a light-tapping component to tap a portion of light from the optical fiber. Applications that require monitoring of the light traveling in an optical fiber typically require only monitoring the light entering and exiting the optical fiber through an optical fiber termination of the optical fiber. Few of these applications absolutely require monitoring of the light traveling in the optical fiber at a certain point along the optical fiber.

At most optical fiber terminations in an optical fiber system, there are optical fiber collimators. The main function of an optical fiber collimator is to optically couple an optical fiber to an optical component. One skilled in the art understands that an optical fiber collimator has other functions and applications. For most of the applications that require monitoring the light traveling in an optical fiber, the conventional light-tapping component in the optical fiber used for monitoring purpose may be replaced by a means for monitoring the light entering or exiting an optical fiber termination of the optical fiber. Further this means for monitoring light may be integrated into the optical fiber collimator at the optical fiber termination. A reduction in system cost may be achieved by employing optical fiber collimators with an integrated means for monitoring light instead of the conventional light-tapping components to monitor the light traveling in the optical fibers. Therefore, it is one of the objects of this invention to provide an optical fiber system that employs optical fiber collimators with integrated photodetectors.

### SUMMARY OF THE INVENTION

According to this invention, an embodiment of the present invention includes an optical fiber system that employs an integrated optical fiber collimator. The integrated optical fiber collimator includes a housing, an optical fiber, and a collimating lens system including one or more lenses. The optical fiber and the collimating lens system in the housing are in optical communication. The integrated optical fiber collimator further includes a beam splitter in the light path in the housing to divert a portion of the light traveling inside the housing to at least one photodetector.

### DESCRIPTION OF THE DRAWINGS

A better understanding of the invention may be gained from the consideration of the following detailed descriptions taken in conjunction with the accompanying drawings in which:

According to this invention, an embodiment of the present invention includes an optical fiber system that employs an integrated optical fiber collimator. The integrated optical fiber collimator includes a housing, an optical fiber, and a collimating lens system including one or more lenses. The optical fiber and the collimating lens system in the housing are in optical communication. The integrated optical fiber collimator further includes a beam splitter in the light path in the housing to divert a portion of the light traveling inside the housing to at least one photodetector.

### DETAILED DESCRIPTION OF THE INVENTION

In the description that follows, like parts are indicated throughout the specification and drawings with the same reference numerals. The present invention is not limited to the specific embodiments illustrated herein.

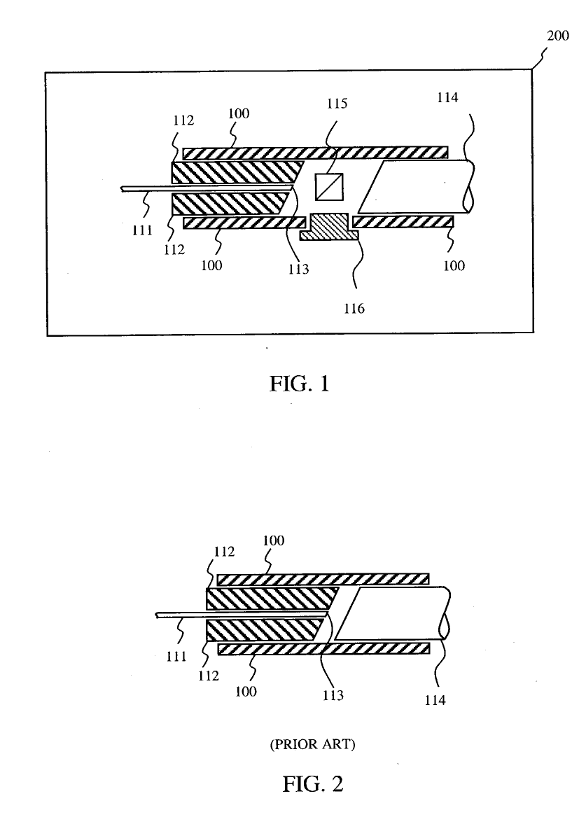

Referring to FIG. 1, an optical fiber system 200 according to this invention includes an optical fiber network of one or more optical fibers, and an integrated optical fiber collimator. The optical fiber system may further include light sources, optical components, control systems, mechanical systems, electrical systems, electro-mechanical systems, electronic systems, and software. FIG. 1 shows the configuration of the integrated optical fiber collimator employed in an embodiment of the present invention. The integrated optical fiber collimator shown in FIG. 1 is based on the prior art design shown in FIG. 2. Referring to FIG. 1, an end portion of optical fiber 111 is inside a fiber ferrule 112. At the end of optical fiber 111 is an optical fiber termination 113. Optical fiber termination 113 and the surface of fiber ferrule 112 adjacent to optical fiber termination 113 are polished. One skilled in the art readily understands that the normal to the polished surfaces of optical fiber termination 113 and fiber ferrule 112 are typically at a small angle to the optical axis of optical fiber 111 at optical fiber termination 113. This small angle is optional and it helps to reduce reflection. Housing 100 holds fiber ferrule 112 and collimating lens 114. Collimating lens 114 collimates the light from optical fiber termination 113 and focuses light external to housing 100 onto optical fiber termination 113. In this embodiment, beam splitter 115 in housing 100 diverts a portion of the light traveling from collimating lens 114 to optical fiber termination 113 to photodetector 116. Beam splitter 115 is attached to housing 100 through a support structure not shown in the figure. Beam splitter 115 splits light of the same wavelength in a light beam to at least two light beams traveling in different directions. Beam splitter 115 is a broadband beam splitter. It is not a wavelength-separating device that allows light of selected wavelengths to pass through and light of the remaining wavelengths diverted. One skilled in the art readily understands that the optical power splitting ratio of a physical beam splitter, such as beam splitter 115, may vary with the specific wavelength of light.

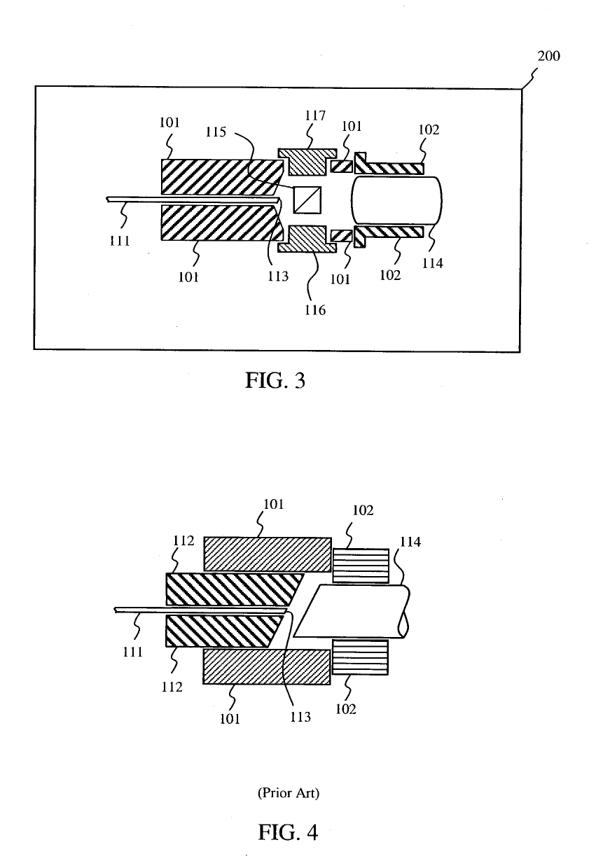

FIG. 3 shows the configuration of an integrated optical fiber collimator employed in an alternative embodiment of this invention. The integrated optical fiber collimator shown in FIG. 3 is based on the prior art design shown in FIG. 4. Referring to FIG. 3, the alternative embodiment has a multiple-piece housing that includes first housing 101 and second housing 102. An end portion of optical fiber 111 is in first housing 101 and attached directly to first housing 101. Collimating lens 114 is in second housing 102. By breaking up the housing into two pieces, first housing 101 and second housing 102, the offset between the optical axis of optical fiber 111 at optical fiber termination 113 and the optical axis of collimating lens 114 can be adjusted during the alignment phase of the fabrication of this embodiment. Beam splitter 115 in first housing 101 diverts a portion of the light traveling from collimating lens 114 to optical fiber termination 113 to photodetector 116 and a portion of the light traveling from optical fiber termination 113 to collimating lens 114 to photodetector 117. Beam splitter 115 is attached to housing 101 through a support structure not shown in the figure.

There are numerous variations to the embodiments disclosed above which are trivial to those skilled in the art. Examples of these variations include but not limited to:

the single collimating lens 114 shown in the figures is replaced by a collimating lens system including at least one lens;

the collimating lens system is disposed between beam splitter 115 and optical fiber termination 113 and additional lenses may be required in some applications to focus the light diverted by beam splitter 115 to the photodetectors;

beam splitter 115 is disposed between the lenses of the collimating lens system;

there are numerous types of beam splitters, including for example: pellicle membrane beam splitters, plate beam splitters, and cube beam splitters; and

there are numerous types of photodetector, including for example: photo diodes, phototransistors, photo-resistors, charge coupled devices, complementary metal oxide semiconductor (CMOS) sensors, photo-multipliers.

Although the embodiment of the invention has been illustrated and the form has been described, it is readily apparent to those skilled in the art that various modifications may be made therein without departing from the spirit of the invention.

What is claimed is:

1. An optical fiber system, comprising:
an optical fiber network having at least one optical fiber;
a light source optically coupled to said optical fiber network; and
an integrated optical fiber collimator providing optical coupling to said optical fiber network, comprising:
a housing;
an optical fiber of said optical fiber network having an optical fiber termination in said housing, an end portion of said optical fiber being in said housing;
a collimating lens system disposed at least partially in said housing being in optical communication with said optical fiber;
a photodetector; and
a beam splitter disposed at least partially in said housing diverting a portion of the light traveling in said housing to said photodetector.

2. The optical fiber system as claimed in claim 1, wherein, said collimating lens system is disposed in an optical path between said beam splitter and said optical fiber termination.

3. The optical fiber system as claimed in claim 1, wherein, said beam splitter is disposed in an optical path between said collimating lens system and said optical fiber termination.

4. The optical fiber system as claimed in claim 1, wherein, said collimating lens system comprises a lens.

5. The optical fiber system as claimed in claim 1, wherein, said collimating lens system comprises a plurality of lenses.

6. The optical fiber system as claimed in claim 5, wherein, said beam splitter is disposed in an optical path between the lenses of said collimating lens system.

7. The optical fiber system as claimed in claim 1, wherein, said beam splitter comprises a plate beam splitter.

8. The optical fiber system as claimed in claim 1, wherein, said beam splitter comprises a cube beam splitter.

9. The optical fiber system as claimed in claim 1, wherein, said beam splitter comprises a Pellicle membrane beam splitter.

10. The optical fiber system as claimed in claim 1, wherein, said photodetector comprises a photodiode.

11. The optical fiber system as claimed in claim 1, wherein, said photodetector comprises a phototransistor.

12. The optical fiber system as claimed in claim 1, wherein, said photodetector comprises a photo-resistor.

13. The optical fiber system as claimed in claim 1, wherein, said photodetector comprises a charge coupled device.

14 The optical fiber system as claimed in claim 1, wherein, said photodetector comprises a CMOS sensor.

15. The optical fiber system as claimed in claim 1, wherein, said photodetector comprises a photo-multiplier.

16. The optical fiber system as claimed in claim 1, wherein, said photodetector is disposed inside said housing.

17. The optical fiber system as claimed in claim 1, wherein, said photodetector is disposed at least partially in said housing.

18. The optical fiber system as claimed in claim 1, wherein, said photodetector is disposed outside said housing.

19. The optical fiber system as claimed in claim 1, wherein, said beam splitter is disposed inside said housing.

20. The optical fiber system as claimed in claim 1, wherein, said beams splitter diverts a portion of the light in said housing that travels from the outside of said housing to said photodetector.

21. The optical fiber system as claimed in claim 1, wherein, said beams splitter diverts a portion of the light in said housing that travels from said optical fiber through said optical fiber termination to said photodetector.

22. The optical fiber system as claimed in claim 1, wherein:
said integrated optical fiber collimator further comprises a second photodetector; and
said beams splitter diverts a portion of the light in said housing traveling from the outside of said housing to said photodetector and diverts a portion of the light in said housing traveling from said optical fiber through said optical fiber termination to said second photodetector.

23. The optical fiber system as claimed in claim 1, wherein, said integrated optical fiber collimator, further comprising:
a fiber ferrule in said housing mechanically supporting a portion of said optical fiber.

24. The optical fiber system as claimed in claim 3, wherein, said beam splitter comprises a cube beam splitter.

25. The optical fiber system as claimed in claim 24, wherein, said collimating lens system comprises a lens.

26. The optical fiber system as claimed in claim 25, wherein, said beam splitter is disposed inside said housing.

27. The optical fiber system as claimed in claim 26, wherein, said photodetector comprises a photodiode.

28. The optical fiber system as claimed in claim 26, wherein, said photodetector is disposed inside said housing.

29. The optical fiber system as claimed in claim 26, wherein, said photodetector is disposed at least partially in said housing.

30. The optical fiber system as claimed in claim 26, wherein, said photodetector is disposed outside said housing.

31. The optical fiber system as claimed in claim 26, wherein, said integrated optical fiber collimator, further comprising:
a fiber ferrule in said housing mechanically supporting a portion of said optical fiber.

32. The optical fiber system as claimed in claim 26, wherein, said beams splitter diverts a portion of the light in said housing that travels from the outside of said housing to said photodetector.

33. The optical fiber system as claimed in claim 26, wherein, said beam splitter diverts a portion of the light in said housing that travels from said optical fiber through said optical fiber termination to said photodetector.

34. The optical fiber system as claimed in claim 1, wherein:
said integrated optical fiber collimator, further comprising a second photodetector; and
said beams splitter diverts a portion of the light in said housing traveling from the outside of said housing to said photodetector and diverts a portion of the light in said housing traveling from said optical fiber through said optical fiber termination to said second photodetector.

35. The optical fiber system as claimed in claim 1, wherein, said housing comprises a multi-piece housing having at least two pieces.

36. The optical fiber system as claimed in claim 35, wherein, said housing further comprises:
a first housing; and
a second housing.

37. The optical fiber system as claimed in claim 36, wherein
said end portion of said optical fiber being in said first housing; and
said collimating lens system being at least partially in said second housing.

38. The optical fiber system as claimed in claim 37, wherein, said integrated optical fiber collimator, further comprising:
a fiber ferrule in said first housing mechanical supporting a portion of said optical fiber.

39. The optical fiber system as claimed in claim 38, wherein, said beam splitter is disposed at least partially in said first housing.

40. The optical fiber system as claimed in claim 38, wherein, said beam splitter is disposed at least partially in said second housing.

41. An optical fiber system, comprising:
an optical fiber network having at least one optical fiber;
a light source optically coupled to said optical fiber network; and
an integrated optical fiber collimator providing optical coupling to said optical fiber network, comprising:
a housing means;
an optical fiber of said optical fiber network extending into said housing means having an optical fiber termination in said housing means;
a collimating means being at least partially in said housing means for collimating the light traveling from said optical fiber through said optical fiber termination into a substantially collimated light beam and collecting light from the outside of said housing means into said optical fiber;
a beam splitting means being at least partially in said housing means for diverting a portion of the light traveling in said integrated optical fiber collimator; and
a monitoring means for monitoring the light diverted by said beam splitting means.

42. The optical fiber system as claimed in claim 41, wherein, said housing means comprises a housing.

43. The optical fiber system as claimed in claim 41, wherein, said housing means comprises a multi-piece housing having at least two pieces.

44. The optical fiber system as claimed in claim 43, wherein, said housing means comprises:
a first housing; and
a second housing.

45. The optical fiber system as claimed in claim 41, wherein, said collimating means comprises a collimating lens system.

46. The optical fiber system as claimed in claim 41, wherein, said collimating lens system comprises at least one lens.

47. The optical fiber system as claimed in claim 41, wherein, beam splitting means comprises a broadband beam splitter.

48. The optical fiber system as claimed in claim 41, wherein, said monitoring means comprises a photodetector.

49. The optical fiber system as claimed in claim 42, wherein, said collimating means comprises a collimating lens system having at least one lens.

50. The optical fiber system as claimed in claim 49, wherein, beam splitting means comprises a broadband beam splitter.

51. The optical fiber system as claimed in claim 50, wherein, said monitoring means comprises a photodetector being disposed to monitor a portion of the light traveling into said housing means.

52. The optical fiber system as claimed in claim 50, wherein, said monitoring means comprises a photodetector being disposed to monitor a portion of the light traveling from said optical fiber through said optical fiber termination.

53. The optical fiber system as claimed in claim 50, wherein, said monitoring means comprises:
a first photodetector being disposed to monitor a portion of the light traveling into said housing means; and
a second photodetector being disposed to monitor a portion of the light traveling from said optical fiber through said optical fiber termination.

54. A method for monitoring the light traveling through an optical fiber that is terminated with an optical fiber collimator in an optical fiber system, comprising:
diverting a portion of the light traveling through said optical fiber collimator at an optical fiber termination of said optical fiber with a beam splitter in the light path inside the optical fiber collimator; and
monitoring the diverted portion of light with at least one photodetector.
